(19) United States
(12) Patent Application Publication
(10) Pub. No.: US 2023/0124782 A1
(43) Pub. Date: Apr. 20, 2023

(54) CUSTOMER AUTHENTICATION APPARATUS, CUSTOMER AUTHENTICATION METHOD, AND NON-TRANSITORY COMPUTER-READABLE STORAGE MEDIUM

(71) Applicant: NEC Corporation, Minato-ku, Tokyo (JP)

(72) Inventor: Masamichi TANABE, Tokyo (JP)

(73) Assignee: NEC Corporation, Minato-ku, Tokyo (JP)

(21) Appl. No.: 17/909,661

(22) PCT Filed: Mar. 12, 2021
(86) PCT No.: PCT/JP2021/010031

§ 371 Date: Sep. 6, 2022

(30) Foreign Application Priority Data
Mar. 24, 2020 (JP) 2020-052760

(51) Int. Cl. G06Q 20/40; G06F 21/40; G06F 21/32; G06F 21/33

(52) U.S. Cl. CPC G06Q 20/40145; G06F 21/40; G06F 21/32; G06F 21/33

(57) ABSTRACT

A customer authentication apparatus includes: a first acquisition unit which acquires master information including face or iris information about a customer, and acquires information of the same kind as that of at least a part of the master information and personal information about the customer from a customer's certificate; a storage processing unit which stores the master information and the personal information in association with each other when the master information and the acquired information of the same kind coincide with each other; a second acquisition unit which acquires, from an in-store capturing apparatus, authentication information including the information of the same kind as that of the master information, and acquires the personal information corresponding the master information when there is the master information that coincides with the authentication information; and an execution unit which causes an in-store apparatus to execute predetermined processing using the personal information.

### TECHNICAL FIELD

The present invention relates to a customer authentication apparatus, a customer authentication method, and a program.

### BACKGROUND ART

When predetermined processing is performed at a store, an administrative body, and the like, personal information about a person himself/herself may be used. For example, Patent Document 1 describes the following technique related to an administrative procedure. First, personal information described on an identification card and an iris are registered in association with each other in a server. Subsequently, when iris information and personal information about a user are transmitted from a terminal to the server, the server performs authentication of the user by using a pair of the iris information and the personal information.

### RELATED DOCUMENT

### Patent Document

[Patent Document 1] Japanese Patent Application Publication No. 2006-48263

### SUMMARY OF INVENTION

### Technical Problem

In recent years, performing processing using personal information about a customer at a store is increasing. The present inventor has considered a reduction in load on a customer when the processing is performed.

One example of an object of the present invention is to reduce a load on a customer when processing using personal information about the customer is performed at a store.

### Solution To Problem

The present invention provides a customer authentication apparatus including:

a first acquisition unit that acquires master information including at least one piece of face information and iris information about a customer, and also acquires information of a same kind as that of at least a part of the master information and personal information about the customer from a certificate possessed by the customer;

a storage processing unit that stores the master information and the personal information in association with each other in a first storage unit when the at least a part of the master information and the information of the same kind being acquired from the certificate coincide with each other;

a second acquisition unit that acquires authentication information from a capturing unit installed in a store, and acquires the personal information associated with the master information when information included in any piece of the master information coincides with the authentication information; and

an execution unit that causes an in-store apparatus installed in a store to execute predetermined processing using the personal information being acquired by the second acquisition unit.

The present invention provides a customer authentication method including,

by a computer:

acquiring master information including at least one piece of face information and iris information about a customer, and also acquiring information of a same kind as that of at least a part of the master information and personal information about the customer from a certificate possessed by the customer;

storing the master information and the personal information in association with each other in a first storage unit when the at least a part of the master information and the information of the same kind being acquired from the certificate coincide with each other;

acquiring authentication information from a capturing unit installed in a store, and acquiring the personal information associated with the master information when information included in any piece of the master information coincides with the authentication information; and

causing an in-store apparatus installed in a store to execute predetermined processing using the acquired personal information.

The present invention provides a program causing a computer to include:

a first acquisition function of acquiring master information including at least one piece of face information and iris information about a customer, and also acquiring information of a same kind as that of at least a part of the master information and personal information about the customer from a certificate possessed by the customer;

a storage processing function of storing the master information and the personal information in association with each other in a first storage unit when the at least a part of the master information and the information of the same kind being acquired from the certificate coincide with each other;

a second acquisition function of acquiring authentication information from a capturing unit installed in a store, and acquiring the personal information associated with the master information when information included in any piece of the master information coincides with the authentication information; and

an execution function of causing an in-store apparatus installed in a store to execute predetermined processing using the personal information being acquired by the second acquisition function.

### ADVANTAGEOUS EFFECTS OF INVENTION

The present invention can reduce a load on a customer when processing using personal information about the customer is performed at a store.

### BRIEF DESCRIPTION OF THE DRAWINGS

FIG. 1 is diagram for describing a usage environment of a customer authentication apparatus according to a first example embodiment.

FIG. 2 is a diagram illustrating one example of a functional configuration of the customer authentication apparatus.

FIG. 3 is a diagram illustrating a hardware configuration example of the customer authentication apparatus.

FIG. 4 is a flowchart illustrating a first example of processing performed by the customer authentication apparatus.

FIG. 5 is a flowchart illustrating a second example of processing performed by the customer authentication apparatus.

FIG. 6 is a flowchart illustrating a third example of processing performed by the customer authentication apparatus.

FIG. 7 is diagram illustrating a usage environment of a customer authentication apparatus according to a second example embodiment.

FIG. 8 is a flowchart illustrating one example of processing performed by the customer authentication apparatus.

FIG. 9 is diagram illustrating a usage environment of a customer authentication apparatus according to a third example embodiment.

### EXAMPLE EMBODIMENT

Hereinafter, example embodiments of the present invention will be described with reference to the drawings. Note that, in all of the drawings, a similar component has a similar reference sign, and description thereof will be appropriately not repeated. Further, in the following description, face information may be a face image or a feature value of a face generated from the face image. Further, iris information may be an iris image or a feature value of an iris generated from the iris image.

### First Example Embodiment

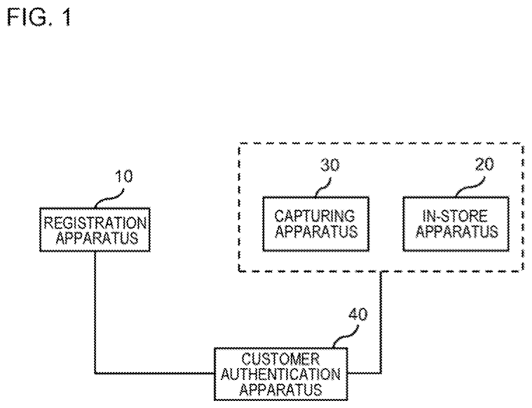

FIG. 1 is diagram for describing a usage environment of a customer authentication apparatus 40 according to the present example embodiment. The customer authentication apparatus 40 is used together with a registration apparatus 10, and an in-store apparatus 20 and a capturing apparatus 30 that are installed at a store, authenticates a customer when the customer uses the in-store apparatus 20, and transmits personal information about the customer to the registration apparatus 10. The customer authentication apparatus 40 may be installed at a store, or may be installed outside a store.

As one example, the in-store apparatus 20 is a product registration apparatus or a settlement apparatus. As another example, the in-store apparatus 20 controls whether a specific product (for example, alcohol and a cigarette) can be taken out or cannot be taken out from a placement region in which the product is placed. For example, the in-store apparatus 20 controls a lock of a door of a product shelf. As still another example, the in-store apparatus 20 is a printing apparatus that prints an address. As still another example, the in-store apparatus 20 is a control apparatus that controls opening and closing of a door of a locker.

A customer registers necessary information in advance in the customer authentication apparatus 40 by using the registration apparatus 10 before the customer uses the in-store apparatus 20. For example, the registration apparatus 10 may be a terminal (for example, a portable terminal) possessed by a customer, may be installed at an entrance of a store, or may be installed in a store. When the registration apparatus 10 is installed in front of an entrance of a store, a door at the entrance of the store may be opened on a condition that the registration apparatus 10 acquires information to be registered in the customer authentication apparatus 40.

Further, information registered by using the registration apparatus 10 is information (hereinafter described as master information) including at least one piece of face information and iris information, and personal information. Among the pieces of information, the master information is generated by the registration apparatus 10. On the other hand, the personal information is acquired from a certificate. The certificate is, for example, at least one of a driver's license, a health insurance card, a passport, and a staff identity card. The personal information is, for example, at least one piece of information (for example, at least one of a birth date, an age, and an age group) related to an age of a customer and address information. The personal information may further include a name of the customer.

The in-store apparatus 20 and the capturing apparatus 30 are disposed close to each other. Specifically, a capturing unit is disposed in a position in which a person who uses the in-store apparatus 20 can be captured. Then, the capturing apparatus 30 includes at least one (preferably both) of a first capturing unit that captures a face of a customer and a second capturing unit that captures an iris of the customer.

When a customer uses the in-store apparatus 20, the capturing apparatus 30 captures the customer and generates authentication information. The authentication information includes information of the same kind as that of at least a part of at least the master information. For example, when the master information includes face information, the authentication information includes the face information. Further, when the master information includes iris information, the authentication information includes the iris information. Furthermore, when the master information includes face information and iris information, the authentication information includes at least one piece (may be both pieces) of the face information and the iris information. Then, when the authentication information and the master information coincide with each other, the customer authentication apparatus 40 reads personal information associated with the master information and transmits the personal information to the in-store apparatus 20.

The in-store apparatus 20 performs predetermined processing by using the personal information acquired from the customer authentication apparatus 40. When the in-store apparatus 20 is a product registration apparatus or a settlement apparatus, the in-store apparatus 20 determines, by using the personal information, whether registration or settlement of a product with an age limit can be performed. Further, when the in-store apparatus 20 controls whether a product with an age limit can be taken out or cannot be taken out from a placement region in which the product is placed, the in-store apparatus 20 determines taking out of the product by using the personal information. Further, when the in-store apparatus 20 is a printing apparatus that prints an address, the in-store apparatus 20 prints an address included in the personal information. Further, when the in-store apparatus 20 is a control apparatus that controls opening and closing of a door of a locker, the in-store apparatus 20 controls opening and closing of a door of a locker by using the personal information.

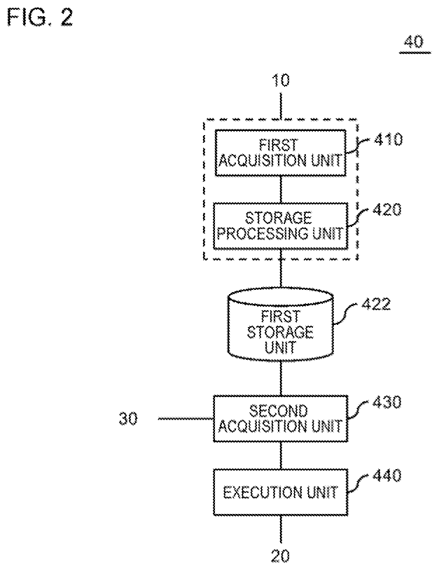

FIG. 2 is a diagram illustrating one example of a functional configuration of the customer authentication apparatus 40. In the example illustrated in FIG. 2, the customer authentication apparatus 40 includes a first acquisition unit 410, a storage processing unit 420, a second acquisition unit 430, and an execution unit 440.

The first acquisition unit 410 acquires the master information and the personal information described above from the registration apparatus 10. Further, information (hereinafter described as authentication biometric information) of the same kind as that of at least a part of the master information is recorded in the certificate. The first acquisition unit 410 also acquires the certificate biometric information together with the master information and the personal information from the registration apparatus 10. For example, when the master information includes face information, the certificate biometric information includes the face information. Further, when the master information includes iris information, the certificate biometric information includes the iris information. Furthermore, when the master information includes face information and iris information, the certificate biometric information includes at least one piece of the face information and the iris information.

The storage processing unit 420 stores the master information and the personal information in association with each other in a first storage unit 422 when at least a part of the master information and the certificate biometric information acquired by the first acquisition unit 410 coincide with each other. The second acquisition unit 430 acquires the authentication information described above from the capturing apparatus 30, and acquires the personal information associated with the master information from the first storage unit 422 when information included in any piece of the master information coincides with the authentication information. The execution unit 440 causes the in-store apparatus 20 to execute predetermined processing using the personal information acquired from the second acquisition unit 430. A specific example of the executed processing is as described above.

In the example illustrated in FIG. 2, the first storage unit 422 is a part of the customer authentication apparatus 40. However, the first storage unit 422 may be located outside the customer authentication apparatus 40. Further, a storage apparatus that stores master information and personal information by the registration apparatus 10 may be different from the first storage unit 422. In this case, the storage apparatus may store information (for example, a membership number and the like) other than the master information and the personal information. Then, the master information and the personal information in the storage apparatus and the master information and the personal information in the first storage unit 422 are synchronized.

Note that, when the registration apparatus 10 is installed at an entrance of a store, information stored in the first storage unit 422 may be deleted after a condition is satisfied after registration. The condition may be, for example, a period (for example, a day, a week, or a month) since registration, or a period since the information is used for the last time.

Further, when the first storage unit 422 is located outside the customer authentication apparatus 40, the first storage unit 422 may be shared among a plurality of the customer authentication apparatuses 40 (i.e., among a plurality of stores). In this case, for example, when information is registered in the first storage unit 422 by using the registration apparatus 10 at an information. In other words, a customer may only need to register information at a certain store.

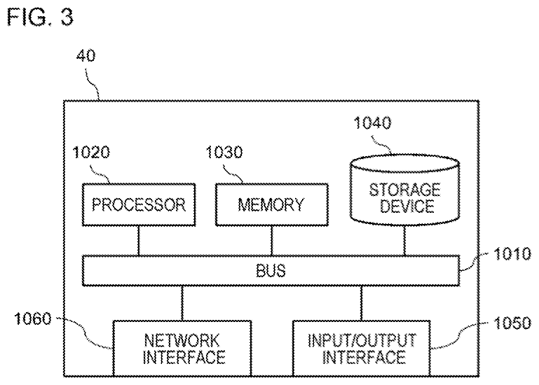

FIG. 3 is a diagram illustrating a hardware configuration example of the customer authentication apparatus 40. The customer authentication apparatus 40 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method of connecting the processor 1020 and the like to each other is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (for example, the first acquisition unit 410, the storage processing unit 420, the second acquisition unit 430, and the execution unit 440) of the customer authentication apparatus 40. The processor 1020 reads each program module onto the memory 1030 and executes the program module, and each function associated with the program module is achieved. Further, the storage device 1040 also functions as the first storage unit 422.

The input/output interface 1050 is an interface for connecting the customer authentication apparatus 40 seed various types of input/output equipment.

The network interface 1060 is an interface for connecting the customer authentication apparatus 40 to a network. The network is, for example, a local area network (LAN) and a wide area network (WAN). A method of connection to the network by the network interface 1060 may be wireless connection or wired connection. The customer authentication apparatus 40 may communicate with the registration apparatus 10, the in-store apparatus 20, and the capturing apparatus 30 via the network interface 1060.

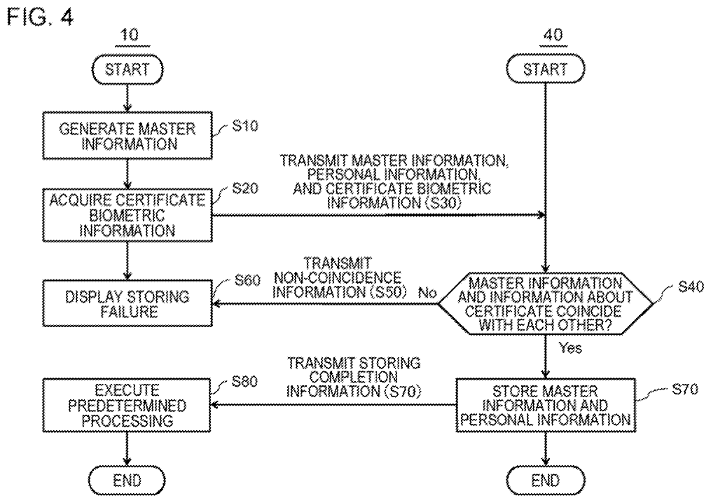

FIG. 4 is a flowchart illustrating a first example of processing performed by the customer authentication apparatus 40. FIG. 4 illustrates processing when the customer authentication apparatus 40 stores master information and personal information in the first storage unit 422.

The registration apparatus 10 includes a capturing unit for generating master information. When the master information includes both pieces of face information and iris information, the registration apparatus 10 includes each of a capturing unit for generating the face information and a capturing unit for generating the iris information. Then, a customer generates the master information by using the capturing unit of the registration apparatus 10 (step S10).

Further, the customer causes the registration apparatus 10 to acquire personal information and certificate biometric information by causing the capturing unit of the registration apparatus 10 to capture a certificate. Herein, processing (for example, character recognition processing or extraction processing of the certificate biometric information) of a generated image may be performed by the registration apparatus 10 or may be performed by the customer authentication apparatus 40. Note that, when a memory is provided with a storage unit such as a magnetic medium in a certificate and the storage unit stores personal information and certificate biometric information, the registration apparatus 10 may read the personal information and the certificate biometric information from the storage unit (step S20).

Next, the registration apparatus 10 transmits the master information, the personal information, and the certificate biometric information to the customer authentication apparatus 40 (step S30).

The first acquisition unit 410 of the customer authentication apparatus 40 acquires the master information, the personal information, and the certificate biometric information from the registration apparatus 10. Next, when the storage processing unit 420 collates the master information and the certificate biometric information with each other, and a score indicating a collation result is equal to or more than a reference value, the storage processing unit 420 determines that the master information and the certificate biometric information coincide with each other (step S40: Yes). Subsequently, the storage processing unit 420 stores the master information and the personal information in association with each other in the first storage unit 422 (step S70), and transmits, to the registration apparatus 10, information indicating completion of storing) of the master information and the personal information in the first storage unit 422 (step S70). Subsequently, the registration apparatus 10 executes predetermined processing.

For example, the registration apparatus 10 may display the information indicating the completion of storing on a display. Further, when the registration apparatus 10 is installed in front of an entrance of a store, the registration apparatus 10 may open a door at the entrance of the store (step S80).

On the other hand, when a score indicating the collation result of the master information and the certificate biometric information is less than the reference value, the storage processing unit 420 determines that the master information and the certificate biometric information do not coincide with each other (step S40), and the storage processing unit 420 transmits, to the registration apparatus 10, information indicating that the master information and the certificate biometric information do not coincide with each other (step S50). Then, the registration apparatus 10 displays information indicating that storing fails on the display (step S60).

Note that, the processing illustrated in step S40 may be performed by the registration apparatus 10. In this case, when a score indicating the collation result of the master information and the certificate biometric information is equal to or more than the reference value, the registration apparatus 10 transmits the master information and the personal information to the customer authentication apparatus 40. Then, steps S50 and S70 are not performed.

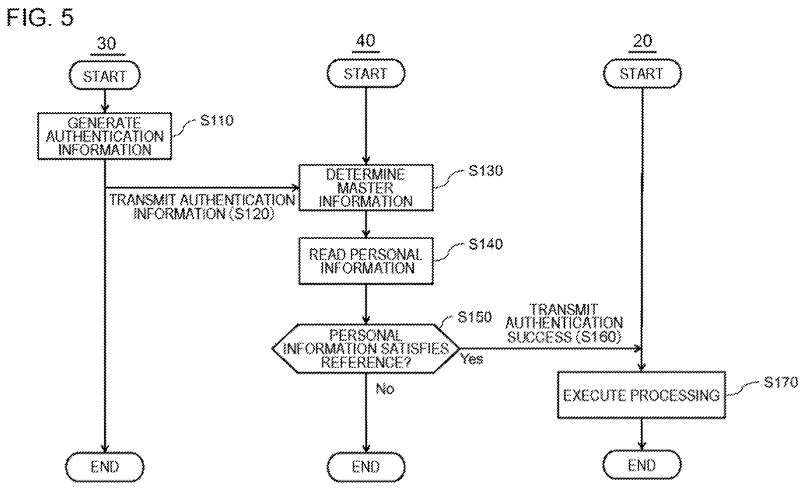

FIG. 5 is a flowchart illustrating a second example of processing performed by the customer authentication apparatus 40. In FIG. 5, the customer authentication apparatus 40 causes the in-store apparatus 20 to perform processing using personal information. In the example illustrated in FIG. 5, the in-store apparatus 20 is a product registration apparatus, a settlement apparatus, or an apparatus that controls whether a product can be taken out or cannot be taken out from a placement region. Then, the personal information stored in the first storage unit 422 includes an age of a customer.

First, a customer who wants to use the in-store apparatus 20 moves close to the in-store apparatus 20. Then, the capturing apparatus 30 associated with the in-store apparatus 20 captures at least one of a face and an iris of the customer, and generates authentication information. As described above in detail, the authentication information includes information of the same kind as that of at least a part of at least master information (step S110). Next, the capturing apparatus 30 transmits the generated authentication information to the customer authentication apparatus 40 (step S120).

The second acquisition unit 430 of the customer authentication apparatus 40 acquires the authentication information from the capturing apparatus 30. Then, the execution unit 440 determines the master information that coincides with the authentication information by using the first storage unit 422 (step S130), and reads an age of the customer associated with the determined master information from the first storage unit 422 (step S140). Then, when the read age satisfies a reference, for example, when the read age is equal to or older than a reference age (step S150: Yes), the execution unit 440 causes the in-store apparatus 20 to execute predetermined processing. As one example, when the in-store apparatus 20 is a product registration apparatus or a settlement apparatus, the in-store apparatus 20 performs processing (for example, registration or settlement of a product with an age limit) related to sales of the product. Further, when the in-store apparatus 20 controls whether a product with an age limit can be taken out or cannot be taken out from a placement region in which the product is placed, the in-store apparatus 20 allows the product to be taken out from the placement region (step S170).

Note that, when the authentication information includes both pieces of face information and iris information, the execution unit 440 may first collate the face information, and collate the iris information when the collation of the face information fails (for example, a customer wears a mask, and the like) in step S130.

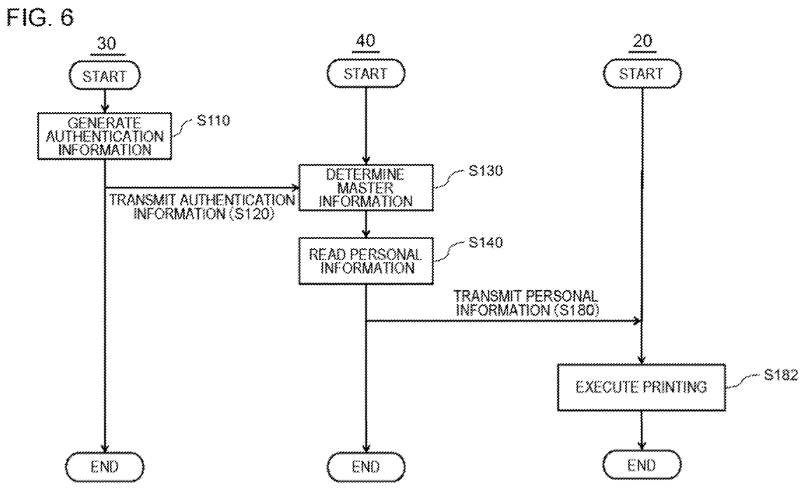

FIG. 6 is a flowchart illustrating a third example of processing performed by the customer authentication apparatus 40. In the example illustrated in FIG. 6, personal information includes an address of a customer. The personal information may further include a name of the customer. Then, the in-store apparatus 20 is a printing apparatus that prints an address of a customer on a slip or the like. The slip here is, for example, a delivery slip, which is not limited thereto.

The processing in steps S110 to S140 is similar to the processing in the example illustrated in FIG. 5. Note that, in step S140, the execution unit 440 of the customer authentication apparatus 40 reads the address of the customer from the first storage unit 422. Here, the execution unit 440 may further read the name of the customer from the first storage unit 422.

Then, the execution unit 440 transmits the information read from the first storage unit 422 to the in-store apparatus 20 (step S180). The in-store apparatus 20 prints the information acquired from the execution unit 440 on a slip, for example, (step S182). Note that, the in-store apparatus 20 may perform other processing using an address and a name of a customer.

As described above, according to the present example embodiment, a customer stores, in association with master information in the customer authentication apparatus 40, personal information stored in a certificate, by using the registration apparatus 10. The master information includes at least one piece of face information and iris information. Then, when the customer uses the in-store apparatus 20 at a store, the customer authentication apparatus 40 identifies the master information that coincides with authentication information generated by the capturing apparatus 30 at the store, and transmits the personal information associated with the master information to the in-store apparatus 20. Thus, a load on the customer when the in-store apparatus 20 performs processing using the personal information about the customer is reduced.

### Second Example Embodiment

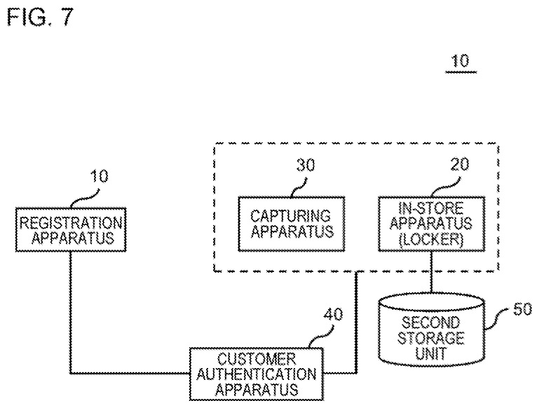

FIG. 7 is diagram illustrating a usage environment of a customer authentication apparatus 40 according to the present example embodiment. In the present example embodiment, an in-store apparatus 20 is a locker of a delivery box and the like, and is provided for a customer to receive a mailing object and a delivery object (hereinafter described as a shipping object) at a store instead of home. Then, when a shipping object is shipped, a shipping person needs to confirm that a customer is located at an address of a shipping destination. However, in the present example embodiment, as described below, a shipping person does not need to directly perform the confirmation.

The in-store apparatus 20 is connected to a second storage unit 50. The second storage unit 50 stores an address of a shipping destination of a shipping object when the shipping object is housed in a locker. The address is input to the second storage unit 50 via the in-store apparatus 20 by a shipping person, for example. Then, the customer authentication apparatus 40 sets, as a necessary requirement for opening a door of a locker, coincidence between the address (i.e., the address specified as the shipping destination) stored in the second storage unit 50 and an address (i.e., an address described in a certificate) read from a first storage unit 422. Note that, the second storage unit 50 may be installed at a store, or may be installed outside a store.

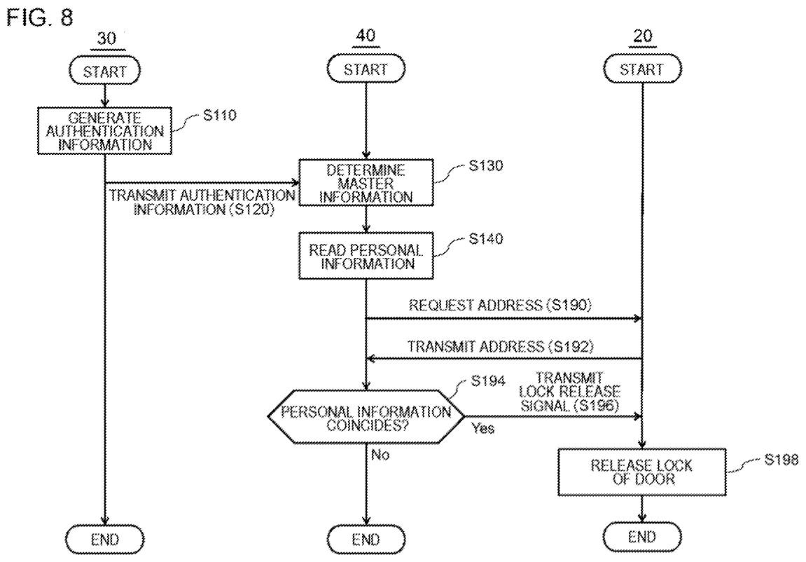

FIG. 8 is a flowchart illustrating one example of processing performed by the customer authentication apparatus 40 according to the present example embodiment. The processing in steps S110 to S140 is similar to the processing in the example illustrated in FIG. 6.

Further, an execution unit 440 of the customer authentication apparatus 40 requests an address stored in the second storage unit 50 from the in-store apparatus 20 concurrently with step S130 and step S140 or after step S140 (step S190). Then, the in-store apparatus 20 reads the address stored in the second storage unit 50, and transmits the address to the execution unit 440 of the customer authentication apparatus 40 (step S192). When the address acquired from the in-store apparatus 20 and an address read from the first storage unit 422 coincide with each other (step S194: Yes), the execution unit 440 performs processing for opening a door of the in-store apparatus 20, i.e., transmits a lock release signal (step S196).

When the in-store apparatus 20 acquires the lock release signal from the customer authentication apparatus 40, the in-store apparatus 20 releases a lock of the door of the in-store apparatus 20 (step S198). In this way, a customer can take out a shipping object from the in-store apparatus 20.

As described above, according to the present example embodiment, when a confirmation that a customer is located at an address of a shipping destination needs to be made, a shipping person can house a shipping object in the in-store apparatus 20. Then, when the customer takes out the shipping object from the in-store apparatus 20, the customer does not need to present a certificate that proves the address. Thus, a load on the customer when the in-store apparatus 20 performs processing using personal information about the customer is reduced.

### Third Example Embodiment

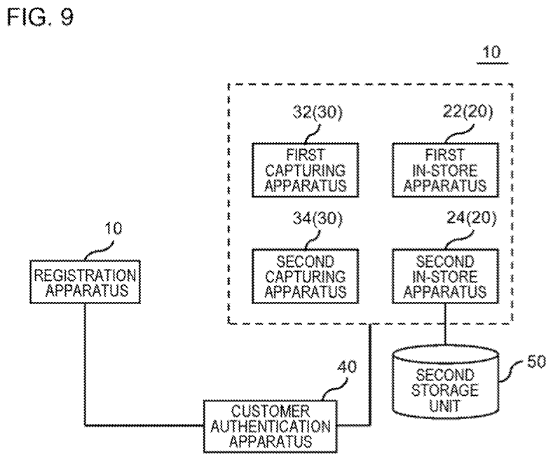

FIG. 9 is diagram illustrating a usage environment of a customer authentication apparatus 40 according to the present example embodiment. In the present example embodiment, a first in-store apparatus 22 and a second in-store apparatus 24 are provided at a store. The first in-store apparatus 22 is one example of an in-store apparatus 20, and controls whether a specific product can be taken out or cannot be taken out from a placement region in which the product is placed. The second in-store apparatus 24 is also one example of the in-store apparatus 20, and is a product registration apparatus or a settlement apparatus.

Further, a first capturing apparatus 32 and a second capturing apparatus 34 are provided at a store. Both of the first capturing apparatus 32 and the second capturing apparatus 34 have a function similar to that of a capturing apparatus 30. Then, the first capturing apparatus 32 is used when a customer uses the first in-store apparatus 22, and the second capturing apparatus 34 is used when a customer uses the second in-store apparatus 24. Then, a group of the first in-store apparatus 22 and the first capturing apparatus 32 and a group of the second in-store apparatus 24 and the second capturing apparatus 34 each perform the processing illustrated in FIG. 5 together with the customer authentication apparatus 40.

Then, the first capturing apparatus 32 generates face information, and the second capturing apparatus 34 generates at least iris information. In other words, authentication using face information is performed when a product is taken out, and authentication using at least iris information (preferably authentication using both pieces of face information and iris information) is performed when a product is purchased. Note that, face authentication may also be used when a product is purchased.

Since an orientation of an eye of a customer needs to match a capturing direction of a capturing apparatus in order to perform iris authentication, a slight load is applied to the customer. In contrast, in the present example embodiment, authentication using face information is performed when a product is taken out. Thus, a load on a customer is reduced. On the other hand, authentication using at least iris information is performed when a product is purchased. Thus, authentication accuracy when a product is purchased increases.

While the example embodiments of the present invention have been described with reference to the drawings, the example embodiments are only exemplification of the present invention, and various configurations other than the above-described example embodiments can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, each of the example embodiments described above can be combined within an extent that a content is not inconsistent.

A part or the whole of the above-described example embodiment may also be described in supplementary notes below, which is not limited thereto.
1. A customer authentication apparatus, including:

a first acquisition unit that acquires master information including at least one piece of face information and iris information about a customer, and also acquires information of a same kind as that of at least a part of the master information and personal information about the customer from a certificate possessed by the customer;

a storage processing unit that stores the master information and the personal information in association with each other in a first storage unit when the at least a part of the master information and the information of the same kind being acquired from the certificate coincide with each other;

a second acquisition unit that acquires authentication information from a capturing unit installed in a store, and acquires the personal information associated with the master information when information included in any piece of the master information coincides with the authentication information; and

an execution unit that causes an in-store apparatus installed in a store to execute predetermined processing using the personal information being acquired by the second acquisition unit.
2. The customer authentication apparatus according to supplementary note 1 described above, wherein

the personal information is related to an age of the customer, and

the execution unit causes the in-store apparatus to execute the predetermined processing when the age satisfies a reference.
3. The customer authentication apparatus according to supplementary note 2 described above, wherein

the in-store apparatus is a product registration apparatus or a settlement apparatus, and

the predetermined processing is processing related to sales of a specific product.
4. The customer authentication apparatus according to supplementary note 2 described above, wherein

a first of the in-store apparatus controls whether a customer can take out or cannot take out a specific product from a placement region in which the product is placed, and

a first of the predetermined processing by the first in-store apparatus is processing of allowing the product to be taken out from the placement region.
5. The customer authentication apparatus according to supplementary note 4 described above, wherein

the master information includes both pieces of the face information and the iris information,

there is further a product registration apparatus or a settlement apparatus as a second of the in-store apparatus,

a second of the predetermined processing by the second in-store apparatus is processing related to sales of the specific product,

a first of the capturing unit for the first in-store apparatus and second of the capturing unit for the second in-store apparatus are provided in the store, and

the first capturing unit generates face information, and the second capturing unit generates at least iris information.
6. The customer authentication apparatus according to supplementary note 1 described above, wherein

the personal information is related to an address of the customer.
7. The customer authentication apparatus according to supplementary note 6 described above, wherein

the predetermined processing is printing of an address of the customer.
8. The customer authentication apparatus according to supplementary note 6 described above, wherein

the in-store apparatus is a locker,

the address of the customer is stored in association with a locker in a second storage unit when the door of the locker is closed, and

the execution unit performs, as the predetermined processing, processing of opening the door of the locker when the address as the personal information being acquired by the second acquisition unit and the address stored in the second storage unit coincide with each other.
9. The customer authentication apparatus according to any one of supplementary notes 1 to 8 described above, wherein

the first acquisition unit acquires the master information, the information of the same kind, and the personal information from a terminal of the customer.
10. The customer authentication apparatus according to any one of supplementary notes 1 to 9 described above, wherein

the first acquisition unit acquires the master information, the information of the same kind, and the personal information from an input apparatus installed at an entrance of the store or in the store.
11. A customer authentication method, including,

by a computer:

acquiring master information including at least one piece of face information and iris information about a customer, and also acquiring information of a same kind as that of at least a part of the master information and personal information about the customer from a certificate possessed by the customer;

storing the master information and the personal information in association with each other in a first storage unit when the at least a part of the master information and the information of the same kind being acquired from the certificate coincide with each other;

acquiring authentication information from a capturing unit installed in a store, and acquiring the personal information associated with the master information when information included in any piece of the master information coincides with the authentication information; and

causing an in-store apparatus installed in a store to execute predetermined processing using the acquired personal information.
12. The customer authentication method according to supplementary note 11 described above, wherein

the personal information is related to an age of the customer,

the customer authentication method further including,

by the computer,

causing the in-store apparatus to execute the predetermined processing when the age satisfies a reference.
13. The customer authentication method according to supplementary note 12 described above, wherein

the in-store apparatus is a product registration apparatus or a settlement apparatus, and

the predetermined processing is processing related to sales of a specific product.
14. The customer authentication method according to supplementary note 12 described above, wherein

a first of the in-store apparatus controls whether a customer can take out or cannot take out a specific product from a placement region in which the product is placed, and

a first of the predetermined processing by the first in-store apparatus is processing of allowing the product to be taken out from the placement region.
15. The customer authentication method according to supplementary note 14 described above, wherein

the master information includes both pieces of the face information and the iris information,

there is further a product registration apparatus or a settlement apparatus as a second of the in-store apparatus,

a second of the predetermined processing by the second in-store apparatus is processing related to sales of the specific product,

a first of the capturing unit for the first in-store apparatus and second of the capturing unit for the second in-store apparatus are provided in the store, and

the first capturing unit generates face information, and the second capturing unit generates at least iris information.
16. The customer authentication method according to supplementary note 11 described above, wherein

the personal information is related to an address of the customer.
17. The customer authentication method according to supplementary note 16 described above, wherein

the predetermined processing is printing of an address of the customer.
18. The customer authentication method according to supplementary note 16 described above, wherein

the in-store apparatus is a locker, and

the address of the customer is stored in association with the locker in a second storage unit when a door of the locker is closed,

the customer authentication method further including,

by the computer,

performing, as the predetermined processing, processing of opening the door of the locker when the address as the personal information being acquired by the second acquisition unit and the address stored in the second storage unit coincide with each other.
19. The customer authentication method according to any one of supplementary notes 11 to 18 described above, further including,

by the computer,

acquiring the master information, the information of the same kind, and the personal information from a terminal of the customer.
20. The customer authentication method according to any one of supplementary notes 11 to 19 described above, further including,

by the computer,

acquiring the master information, the information of the same kind, and the personal information from an input apparatus installed at an entrance of the store or in the store.
21. A program causing a computer to include:

a first acquisition function of acquiring master information including at least one piece of face information and iris information about a customer, and also acquiring information of a same kind as that of at least a part of the master information and personal information about the customer from a certificate possessed by the customer;

a storage processing function of storing the master information and the personal information in association with each other in a first storage unit when the at least a part of the master information and the information of the same kind being acquired from the certificate coincide with each other;

a second acquisition function of acquiring authentication information from a capturing unit installed in a store, and acquiring the personal information associated with the master information when information included in any piece of the master information coincides with the authentication information; and

an execution function of causing an in-store apparatus installed in a store to execute predetermined processing using the personal information being acquired by the second acquisition function.
22. The program according to supplementary note 21 described above, wherein

the personal information is related to an age of the customer, and

the execution function causes the in-store apparatus to execute the predetermined processing when the age satisfies a reference.
23. The program according to supplementary note 22 described above, wherein

the in-store apparatus is a product registration apparatus or a settlement apparatus, and

the predetermined processing is processing related to sales of a specific product.
24. The program according to supplementary note 22 described above, wherein

a first of the in-store apparatus controls whether a customer can take out or cannot take out a specific product from a placement region in which the product is placed, and

a first of the predetermined processing by the first in-store apparatus is processing of allowing the product to be taken out from the placement region.
25. The program according to supplementary note 24 described above, wherein

the master information includes both pieces of the face information and the iris information,

there is further a product registration apparatus or a settlement apparatus as second of the in-store apparatus,

a second of the predetermined processing by the second in-store apparatus is processing related to sales of the specific product,

a first of the capturing unit for the first in-store apparatus and a second of the capturing unit for the second in-store apparatus are provided in the store, and

the first capturing unit generates face information, and the second capturing unit generates at least iris information.
26. The program according to supplementary note 21 described above, wherein

the personal information is related to an address of the customer.
27. The program according to supplementary note 26 described above, wherein

the predetermined processing is printing of an address of the customer.
28. The program according to supplementary note 26 described above, wherein

the in-store apparatus is a locker,

the address of the customer is stored in association with the locker in a second storage unit when a door of the locker is closed, and

the execution function performs, as the predetermined processing, processing of opening the door of the locker when the address as the personal information being acquired by the second acquisition function and the address stored in the second storage unit coincide with each other.
29. The program according to any one of supplementary notes 21 to 28 described above, wherein

the first acquisition function acquires the master information, the information of the same kind, and the personal information from a terminal of the customer.
30. The program according to any one of supplementary notes 21 to 29 described above, wherein

the first acquisition function acquires the master information, the information of the same kind, and the personal information from an input apparatus installed at an entrance of the store or in the store.

This application is based upon and claims the benefit of priority from Japanese patent application No. 2020-052760, filed on Mar. 24, 2020, the disclosure of which is incorporated herein in its entirety by reference.

### REFERENCE SIGNS LIST

10 Registration apparatus
20 In-store apparatus
22 First in-store apparatus
24 Second in-store apparatus
30 Capturing apparatus
32 First capturing apparatus
34 Second capturing apparatus
40 Customer authentication apparatus
50 Second storage unit
410 First acquisition unit
420 Storage processing unit
422 First storage unit
430 Second acquisition unit
440 Execution unit

What is claimed is:

1. A customer authentication apparatus, comprising:
at least one memory configured to store instructions; and
at least one processor configured to execute the instructions to:
acquires acquire master information including at least one piece of face information and iris information about a customer, and also acquire information of a same kind as that of at least a part of the master information and personal information about the customer from a certificate possessed by the customer;
store the master information and the personal information in association with each other in a first storage unit when the at least a part of the master information and the information of the same kind being acquired from the certificate coincide with each other;
acquire authentication information from a capturing unit installed in a store, and acquire the personal information associated with the master information when information included in any piece of the master information coincides with the authentication information; and
cause an in-store apparatus installed in a store to execute predetermined processing using the personal information being acquired.

2. The customer authentication apparatus according to claim 1, wherein the personal information is related to an age of the customer, and the at least one processor is further configured to execute the instructions to cause the in-store apparatus to execute the predetermined processing when the age satisfies a reference.

3. The customer authentication apparatus according to claim 2, wherein
the in-store apparatus is a product registration apparatus or a settlement apparatus, and
the predetermined processing is processing related to sales of a specific product.

4. The customer authentication apparatus according to claim 2, wherein
a first of the in-store apparatus controls whether a customer can take out or cannot take out a specific product from a placement region in which the product is placed, and
a first of the predetermined processing by the first in-store apparatus is processing of allowing the product to be taken out from the placement region.

5. The customer authentication apparatus according to claim 4, wherein
the master information includes both pieces of the face information and the iris information,
there is further a product registration apparatus or a settlement apparatus as a second of the in-store apparatus,
a second of the predetermined processing by the second in-store apparatus is processing related to sales of the specific product,
a first of the capturing unit for the first in-store apparatus and a second of the capturing unit for the second in-store apparatus are provided in the store, and
the first capturing unit generates face information, and the second capturing unit generates at least iris information.

6. The customer authentication apparatus according to claim 1, wherein
the personal information is related to an address of the customer.

7. The customer authentication apparatus according to claim 6, wherein
the predetermined processing is printing of an address of the customer.

8. The customer authentication apparatus according to claim 6, wherein
the in-store apparatus is a locker,
the address of the customer is stored in association with the locker in second storage unit when a door of the locker is closed, and
the at least one processor is further configured to execute the instructions to
perform, as the predetermined processing, processing of opening the door of the locker when the address as the personal information being acquired and the address stored in the second storage unit coincide with each other.

9. The customer authentication apparatus according to claim 1, wherein
the at least one processor is further configured to execute the instructions to
acquire the master information, the information of the same kind, and the personal information from a terminal of the customer.

10. The customer authentication apparatus according to claim 1, wherein
the at least one processor is further configured to execute the instructions to
acquire the master information, the information of the same kind, and the personal information from an input apparatus installed at an entrance of the store or in the store.

11. A customer authentication method, comprising,
by a computer:
acquiring master information including at least one piece of face information and iris information about a customer, and also acquiring information of a same kind as that of at least a part of the master information and personal information about the customer from a certificate possessed by the customer;
storing the master information and the personal information in association with each other in a first storage unit when the at least a part of the master information and the information of the same kind being acquired from the certificate coincide with each other;
acquiring authentication information from capturing unit installed in a store, and acquiring the personal information associated with the master information when information included in any piece of the master information coincides with the authentication information; and
causing an in-store apparatus installed in a store to execute predetermined processing using the acquired personal information.

12.-19. (canceled)

20. The customer authentication method according to claim 11, further comprising,
by the computer,
acquiring the master information, the information of the same kind, and the personal information from an input apparatus installed at an entrance of the store or in the store.

21. A non-transitory computer-readable storage medium storing a program causing a computer to execute:
a first acquisition process of acquiring master information including at least one piece of face information and iris information about a customer, and also acquiring information of a same kind as that of at least a part of the master information and personal information about the customer from a certificate possessed by the customer;
a storage processing process of storing the master information and the personal information in association with each other in a first storage unit when the at least a part of the master information and the information of the same kind being acquired from the certificate coincide with each other;
a second acquisition process of acquiring authentication information from capturing unit installed in a store, and acquiring the personal information associated with the master information when information included in any piece of the master information coincides with the authentication information; and
an execution process of causing an in-store apparatus installed in a store to execute predetermined processing using the personal information being acquired by the second acquisition function.

22-29. (canceled)

30. The non-transitory computer-readable storage medium according to claim 21, wherein the program causes the computer to execute
the first acquisition process of acquiring the master information, the information of the same kind, and the personal information from an input apparatus installed at an entrance of the store or in the store.
